(19) United States
(12) Patent Application Publication
(10) Pub. No.: US 2010/0068471 A1
(43) Pub. Date: Mar. 18, 2010

(54) THERMAL RESISTOR MATERIAL

(75) Inventors: Neil D. Lubart, Austin, TX (US); Timothy J. Wojciechowski, Westlake, OH (US)

Correspondence Address: PEPPER HAMILTON LLP, ONE MELLON CENTER, 50TH FLOOR, 500 GRANT STREET, PITTSBURGH, PA, 15219, US

(73) Assignee: THIN THERMAL BARRIERS LIMITED, Milton Keynes (GB)

(21) Appl. No.: 12/557,849

(22) Filed: Sep. 11, 2009

Related U.S. Application Data
(60) Provisional application No. 61/097,051, filed on Sep. 15, 2008.

(51) Int. Cl. B32B 3/00

(52) U.S. Cl. 428/172; 428/156

(57) ABSTRACT

An insulating material having structures and a design that maximizes vacuum area relative to material volume and minimizes the area of contact to a region to be insulated in order to provide maximum thermal resistance between the contacted area and an external environment is provided.

This application claims priority under 35 U.S.C. §119(e) to U.S. Provisional Patent Application Ser. No. 61/097,051, filed Sep. 15, 2008, the disclosure of which is incorporated by reference in its entirety.

### BACKGROUND OF THE INVENTION

1. Field of the Invention

The invention generally relates to an insulating material. In particular, the invention relates to an insulating material in an open cell configuration having structures and a design that maximizes vacuum area relative to material volume and minimizes the area of contact to the region to be insulated in order to provide maximum thermal resistance between the area of contact and an external environment.

2. Description of the Related Art

Many industries utilize thermal resistant materials in an effort to regulate or maintain a desired temperature of an object. Various types of insulation have been utilized to provide thermal insulating properties. One such example is foam insulation. Foam insulation has a cellular structure and contains two phases, a gas phase and a solid phase. The thermal conductivity of foam insulation is determined by the sum of the heat flow through the gas contained within the cells and through the network of cell walls. Typical foam insulation structures include polyurethane, polystyrene, polyisocyanurate, polyimide and foam glass.

Other insulation systems include evacuated spaces of various shapes containing bulk-filled materials, e.g., glass fiber, silica aerogel or composite materials. The conductive heat flow path is limited to the points of contact between the particles or fibers and is impeded by phase discontinuities. The contribution of convective heat flow can be minimized by reducing the interstitial gas pressure and/or reducing the size of the particles so that the equivalent diameter of the voids is equal to or smaller than the mean free path of the gas molecules at the given temperature and pressure.

### SUMMARY OF THE INVENTION

Embodiments of the invention are directed to an insulating material comprising an open cell network formed of a ceramic or polymer layer, wherein the ceramic or polymer layer comprises a substrate having at least one structure, and wherein the arrangement of the ceramic or polymer layer allows for the creation of a high-volume cavity near vacuum pressure within each of the layers that may be sealed using vacuum barriers at the perimeter of the ceramic or polymer layer. In certain embodiments, the at least one structure provides structural support to the cavity while creating a large volume region thereby enabling the open cell structure.

Other embodiments of the invention are directed to an insulating material device, including a four-layer stratum, wherein a stratum can also be composed of two or three layers, comprising an open cell network formed of a first ceramic or polymer layer, wherein the first ceramic or polymer layer comprises a first structure; a second ceramic or polymer layer, wherein the second ceramic or polymer layer comprises a second structure; a first intermediate layer, wherein the first intermediate layer comprises a third structure; a second intermediate layer, wherein the second intermediate layer comprises a fourth structure and a reflective material layer. The arrangement of the first and second ceramic or polymer layers, the first and second intermediate layers, and the reflective material layer allows for the creation of a vacuum within each of said layers that may be sealed. The insulating material further includes a protective polymer coating, which acts as a vacuum barrier that creates the insulating material, wherein about 1% or less of the total surface area of the first, second, third and fourth structures are in contact with each other.

In certain embodiments of the invention, the insulating material device may further include at least a second stratum of two, three, or four layers. A second stratum of four layers may comprise an open cell network formed of a first ceramic or polymer layer, wherein the first ceramic or polymer layer comprises a first structure; a second ceramic or polymer layer, wherein the second ceramic or polymer layer comprises a second structure; a first intermediate layer, wherein the first intermediate layer comprises a third structure; a second intermediate layer, wherein the second intermediate layer comprises a fourth structure and a reflective material layer, wherein the arrangement of the first and second ceramic or polymer layers, the first and second intermediate layers, and the reflective material layer allows for the creation of a vacuum within each of said layers that may be sealed.

In some embodiments, the insulating material device further includes a gas barrier layer per layer, a moisture barrier layer per layer, nano-coating material, a heat seal layer and/or a layer of vacuum deposited materials that include metals. In other embodiments, the insulating material device includes a second stratum. In still other embodiments, the insulating device includes multiple internal perimeter vacuum sealed layers. In further embodiments, the insulating material device is formed to a predetermined portion of the surface of a container and in certain embodiments, the insulating material device is formed in the shape of a cylinder or is substantially cylindrically shaped, and is sealed at a near vacuum pressure to create an insulating interior or exterior layer for a beverage or other container.

According to other embodiments, adjacent layers may be positioned orthogonal to each other. In yet other embodiments, the first ceramic or polymer layer in the stratum may be placed offset from the second intermediate layer and the second ceramic or polymer layer may be placed offset from the first intermediate layer. In further aspects of the invention, the insulating material device is dried, vacuum sealed and/or heat sealed.

### BRIEF DESCRIPTION OF THE FIGURES

The invention may be more completely understood in consideration of the following detailed description of various embodiments of the invention in connection with the accompanying drawings, in which:

FIG. 1 is a cross-sectional view of a lenticular projection structure in accordance with an embodiment of the invention;

FIG. 2 illustrates post structures in accordance with yet another embodiment of the invention;

FIG. 3 is a cross-sectional view of an accordion-shape structure in accordance with another embodiment of the invention; and

FIG. 4 depicts a four-layer stratum of an insulating material device in accordance with one embodiment of the invention.

### DESCRIPTION OF ILLUSTRATIVE EMBODIMENTS

The terminology used herein is for the purpose of describing particular versions or embodiments only and is not intended to limit the scope of the invention. Unless defined otherwise, all terms of art, notations and other scientific terms or terminology used herein have the same meaning as is commonly understood by one of ordinary skill in the art to which this invention belongs. In some cases, terms with commonly understood meanings are defined herein for clarity and/or for ready reference, and the inclusion of such definitions herein should not necessarily be construed to represent a substantial difference over what is generally understood in the art. However, in case of conflict, the patent specification, including definitions, will prevail.

In describing the invention, the following meanings are attributed to the terms employed.

As used herein, the singular forms “a”, “an” and “the” means at least one, but also may include plural reference unless the context clearly dictates otherwise.

As used herein, the term “about” means plus or minus 10% of the numerical value of the number with which it is being used. Therefore, about 50% means in the range of 40%-60%.

As used herein, the terms “device” and “insulating material device” refer to the insulating material of the invention in its end use application.

The terms “insulating material”, “insulating film”, and “thermal resistant layer” are used interchangeably herein.

Embodiments of the invention are directed to an insulating material including multiple layers in an open cell structure that are collectively or individually vacuum sealed in a protective polymer coating to maintain a near vacuum between the layers. The term “open cell”, as used herein, refers to a structure having a series of channels and interconnected passageways that define a substantially open configuration. In certain embodiments, the open cell network of the insulating material may be characterized by at least 40% vacuum area relative to material volume. Without wishing to be bound by theory, the open cell structure allows for maximization of vacuum area relative to material volume. Additionally, the insulating material of the invention provides support to maintain integrity of the material, or in other embodiments, imparts flexibility.

Various embodiments of the invention are directed to an insulating material including multiple layers in an open cell structure that achieves a desired thermal resistance while simultaneously minimizing the thickness of the material, maximizing vacuum area relative to material volume, minimizing the area of contact to the region to be insulated, and providing both structural support and flexibility.

The insulating material of embodiments of the invention includes at least one layer, and preferably, at least two layers. In some embodiments, each layer may have a thickness of about 0.01 mm to 1 mm. The insulating material of the invention may be formed of a variety of materials, such as, for example, polymer layers, ceramic layers, composite layers, and reflective material layers. Non-limiting examples of ceramic layer materials include mullite, soda-lime glass, borosilicate, and zirconia to name a few. When the insulating material is formed from a polymer, an opaque material with a low thermal conductivity may be used. Among the numerous polymers which may be used in accordance with this invention, the following may be mentioned as non-limiting examples: polystyrene, polyvinyl chloride, polyethylene, polypropylene, polyacrylonitrile, polybutadiene, polyisoprene, polytetrafluoroethylene, polyesters, melamine, urea, phenol resins, silicate resins, polyacetal resins, polyepoxides, polyhydantoins, polyureas, polyethers, polyurethanes, polyisocyanurates, polyimides, polyamides, polysulphones, polycarbonates, and copolymers and mixtures thereof. The insulating material of some embodiments may further include additives such as, for example, colorants, UV stabilizers, preservatives, degassing agents, strengthening agents, antioxidants, fillers, adhesives, thickeners, and the like.

According to embodiments of the invention, each layer may include one or more structures of various shapes such that the shapes and the arrangement of such structures allows for the creation of a vacuum within each layer that may be sealed by the layer above or below it and ultimately vacuumed sealed at the perimeter in a protective polymer barrier coating when the surrounding pressure is lowered. In certain embodiments, each layer of the insulating material may include one or more structures including, but not limited to, lenticular projections, accordion-shaped structures, posts and cross-sections of posts that are t-shaped, u-shaped, square, rectangular, or any irregular or regular polyhedron and the like, posts and cross-sections of posts that are curved such as circles, hooks, ellipses and the like, and combinations thereof. In certain embodiments, the layer may include structures of the same shape and in alternate embodiments, the layer may include structures of different shapes. In yet other embodiments, the number of structures is minimized to maximize vacuum area thereby providing maximum thermal resistance.

The structures of the invention may be positioned in a variety of ways to allow for vacuum sealing of the insulating material. In some embodiments of the invention, the structures may extend from a base substrate and may be equally or irregularly spaced on such base substrate. The substrate of the invention may have a single structure or multiple structures extending from one or both sides of the substrate. In some embodiments, multiple substrates may be stacked in such a way as to increase the thermal resistance of the insulating material. In certain embodiments, the base substrate may include a component that acts to effectively block UV, visible, and IR radiation. The base substrate may also contain pigments with relevant absorbers.

In some embodiments, the structures are integral to the substrate. The structures of other embodiments may extend from only one side of the base substrate. In other embodiments, the structures extend from both sides of the substrate. In certain embodiments of the invention, the portion of the structure extending from the base substrate may be larger than the tip of the structure. This may be advantageous for a number of reasons, including, but not limited to, providing structural strength as pressure is lowered, removing mass, and increasing the thermal resistance per layer. Further, as the contact area of the tip of the structure is decreased as a percentage of the total area, the thermal resistance increases. In preferred embodiments, about 1% or less of the total surface area of the structure on any layer is in contact with the structures of an adjacent layer.

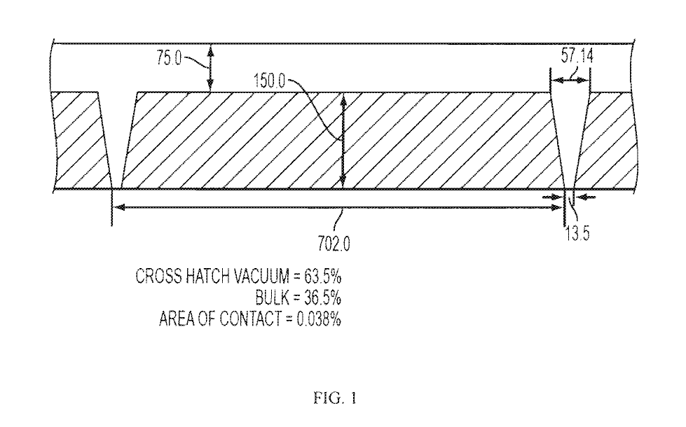

The structures of particular aspects of the invention may take the form of lenticular or crossed-lenticular projections that extend from a base substrate. A cross-sectional view of insulating material having a lenticular projection structure that minimizes contact area to the area insulated of one embodiment of the invention is illustrated in FIG. 1. The lenticular projection structure of various embodiments may be curved, straight, or a combination thereof. In certain embodiments, the base of the lenticular projection may be larger than the tip of the projection.

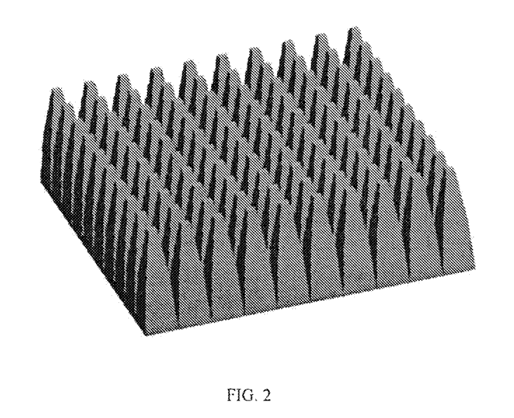

In other aspects of the invention, the structures may include posts, as illustrated in FIG. 2. The posts of the invention are not limited by shape and can be any shape known in the art, such as, for example, rectangular or square. The cross-section of these posts, for example, trapezoidal and the like, may be any shape, including curved, such that these shapes provide sufficient structural support while creating a large volume region. This structure arrangement is similar to the lenticular projection structure except that the lenticular projections are periodically interrupted, the equivalent of crossed-lenticular projections, where a square post results if the periodicity is the same in orthogonal directions or a rectangular post results if the periodicity is different in orthogonal directions. In a preferred embodiment, the number of posts is minimized, by, for example, increasing periodicity/spacing between posts. The periodic interruptions result in increased spacing between the posts, which maximizes the vacuum area thereby maximizing the thermal resistance of the material.

According to some embodiments where there are two or more layers and where lenticular projections are utilized, the second layer may be placed over the first layer with either the corresponding base substrates or the lenticular projection structures touching. In some embodiments of the invention, the second layer may be placed so that its lenticular projection structures are parallel to the projections of the first layer. Without wishing to be bound by theory, in embodiments where the two layers are placed so that the projections are parallel, the thermal resistance may be approximated by a cylindrical thermal conductor. In preferred embodiments, two layers are placed such that the projections are orthogonal to each other, thereby providing a relatively higher thermal resistance than when the projections are in the parallel configuration. In this embodiment where the projections are orthogonal, without wishing to be bound by theory, the thermal resistance may be approximated by a spherical thermal conductor.

Analytical models for thermal resistance may be applied for cylindrical and spherical thermal conductors, respectively. For ease of computation, the structures analyzed are indentations in a thermally resistant material that are turned into vacuum areas, in the shape of an isosceles trapezoid. The lenticular projection structures between the vacuum areas have a width (B) at the base of the projection, an angle of 90°+θ at the tip of the projection having a width (b), and height (H) of the projection. Without wishing to be bound by theory, the isosceles triangle region may be assumed to be a vacuum and all thermal losses may be assumed to occur by conduction through the thermally resistant material that contains the indentations. Thermal flow in the indentions may be limited due to the vacuum in that region. Without wishing to be bound by theory, the effective thermal resistance of the vacuum region may be considered as sufficiently large so that the effective thermal resistance of the insulating material may be equated to that of the thermal resistance of the material region alone, the region containing the structures. For example, if the thermal resistance of the vacuum region is ten times that of the material region, the thermal resistance of the combination is lowered by just 9% compared to the material region alone because the vacuum and material regions are in a parallel configuration.

According to analytical models for thermal resistance in certain embodiments of the invention, a single layer has indentations on one side only, with the other side being smooth. The thickness of the layer may be defined as (t). In some embodiments, the insulating material has at least two such layers, where the second layer may be a mirror image of the first layer, with two possible configurations as discussed above for the second layer (i.e., parallel and orthogonal). For example, in some embodiments, the lenticular projections of the second layer are parallel to the lenticular projections of the first layer with the insulating material being approximated by a radial flow of heat between two coaxial cylinders. Alternatively, the lenticular projections of the second layer may be placed orthogonal to the lenticular projections of the first layer with the insulating material being approximated by a radial flow of heat between two concentric spheres.

Without wishing to be bound by theory, the thermal resistance of an insulating material device with two layers can be approximated as twice that of a single layer (R_{EFF}). Further, number (N) of insulating material devices each having two layers may be stacked and the stack would have a thermal resistance (N) times that of a single device. The separation between isosceles triangles can be approximated by a section of the circumference of a circle of radius (r₁) and angular size (q). The radius (r₁) is derived below in terms of the structure parameters. The flow of heat can be represented approximately as radial flow along the sides of the isosceles triangle of angular size (q). The heat flows out to a radius defined as (r₂), derived below as a function of the structure parameters. Once the heat expands past the apex of the isosceles triangle, any heat flowing out from the structure laterally will be replenished by heat flowing in from adjacent structures.

The effective thermal resistance of a single layer is related to the effective thermal conductivity (k_{EFF}) and thickness (t) of the layer by:

R_{EFF}=t/k_{EFF} (1)

The effective thermal conductivity for an insulating material containing layers having parallel projections can be approximated from the thermal conductivity equation for concentric cylinders. This includes physical properties of the layer. The equation is given by:

dQ/dt=−k(θπ/180)rLdT/dr (2)

where
L=length of the layer whose cross-section is an isosceles triangle
dQ/dt=rate of flow of heat
k=thermal conductivity of the material of the layer
r=radial direction of the heat flow
dT/dr=gradient of temperature in the radial direction

The integral can be written as:

(dQ/dt)∫(dr/r)=−k(θπ/180)L∫dT (3)

where the limits on the radial integral are between r₁ and r₂, and the limits on the temperature integral are between the internal temperature (T_{I}) and the temperature at the middle of the first layer with an outside temperature of T_{O}[(T_{O}+T_{I})/2n]. Although it is assumed that the interior temperature will not change, this will not affect the calculation of the effective thermal resistance (R_{EFF}) of the single layer, which is a physical parameter of the system. This approach does not provide a calculation of the time dependent temperature behavior of the system.

This integral equation can be solved to yield:

dQ/dt=k(θπ/180)[ln(r₂/r₁)]⁻¹L{T_{I}−[(T_{O}+T_{I})/2n]} (4)

From equation (4) it can be observed that the term between the equal sign and (L) is k_{EFF}, which includes the effects of the structural parameters and thermal conductivity of the material.

k_{EFF}=k(θπ/180)[ln(r₂/r₁)]⁻¹ (5)

Equation (5) can be substituted into equation (1) to yield the effective thermal resistance (R_{EFF}):

R_{EFF}=t ln(r₂/r₁)[k(θπ/180)]⁻¹ (6)

The parameters of the system (θ, r₁, r₂) may be calculated in terms of the known structure parameters of the device. Based on geometry, the parameters can be derived to be:

θ=2 tan⁻¹(B/2H) (7)

r₁=(b/2)[1+(4H²/B²)]^{1/2} (8)

r₂=H[1+(B²/4H²]^{1/2}+(b/2)[1+(4H²/B²)]^{1/2} (9)

Without wishing to be bound by theory, k_{EFF} for an insulating material containing orthogonal projections in the layers can be approximated from the thermal conductivity equation for concentric spheres. This approximation includes physical properties of the layer. The equation is given by:

dQ/dt=−k2π(L/t)(1−cos θ)r²dT/dr (10)

where
L=length of the layer, which is equal to the thickness (t) for a device that is represented by concentric spheres
dQ/dt=rate of flow of heat
k=thermal conductivity of the material of the layer
r=radial direction of the heat flow
dT/dr=gradient of temperature in the radial direction

The integral can then be written as:

(dQ/dt)∫(dr/r²)=−k2π(L/t)(1−cos θ)∫dT (11)

where the limits on the radial integral are between r₁ and r₂, and the limits on the temperature integral are between the internal temperature (T_{I}) and the temperature at the middle of the first layer with an outside temperature of T_{O} [(T_{O}+T_{I})/2n]. It is assumed that the interior temperature will not change, although any change in temperature will not affect the calculation of the R_{EFF} of the single layer, which is a physical parameter of the system. However, this approach does not allow for the calculation of the time dependent temperature behavior of the system.

This integral equation can be solved to yield:

dQ/dt=k2π(1−cos θ){r₁r₂/[(r₂−r₁)t]}L{T_{I}−[(T_{O}+T_{I})/2n]} (12)

From equation (12) it can be readily observed, as in equation (4), that the term between the equal sign and L is k_{EFF}, which contains the effects of the structural parameters and thermal conductivity of the material.

k_{EFF}=k2π(1−cos θ){r₁r₂/[(r₂−r₁)t]} (13)

Equation (13) can be substituted into equation (1) to yield the effective thermal resistance (R_{EFF}):

R_{EFF}=t{k2π(1−cos θ){r₁r₂/[(r₂−r₁)t]}⁻¹ (14)

The parameters of the system (θ, r₁, r₂) may be calculated based the structure parameters of the device in equations (7), (8), and (9) above.

The configuration of at least two layers of insulating material forms a stratum of insulating material. As used herein, the term “stratum” refers to layers of material where at least one portion of one layer is arranged on top of at least one portion of another layer. In some embodiments of the invention, the insulating material device includes one stratum, but other embodiments may include multiple strata. In various embodiments, each layer comprising the stratum may be about 10 to about 1000 μm thick. In certain embodiments, each layer comprising a stratum may be about 100 μm thick. In other embodiments, the insulating material device may have a thickness of about 0.1 mm to about 10 mm. In yet other embodiments, the device may have a thickness of about 5 mm.

The number of strata in an insulating material device determines the thermal resistance (R) value of the insulator. The R value of a stratum may be determined based on the geometry of the layer(s), the thermal conductivity of the material making up the layer(s), the vacuum pressure, and ratio of the volume of the material of the layer(s) to the volume of the vacuum. Increasing the spacing between protuberances increases the ratio of the vacuum to the volume of the material of the layer(s). Reducing the projection height reduces the height of the vacuum region. Depending on the vacuum pressure, this could lead to fewer collisions between molecules in the vacuum region and allow higher pressure for a given thermal resistance. Thus, higher vacuum pressures may be utilized to obtain a given thermal resistance to make the insulating material easier to manufacture and enable mass production of flexible vacuum insulation panels. Additionally, in certain embodiments, if a predetermined R value is desired, the number of stratum necessary to achieve the desired R can be calculated. The insulating material device of the invention may have an R value from about 2.5 to about 6 in units of K-m²/W. In some embodiments where relatively thinner layers are utilized, the R value may be even higher as the thin layers allow for more stratum for a given device thickness.

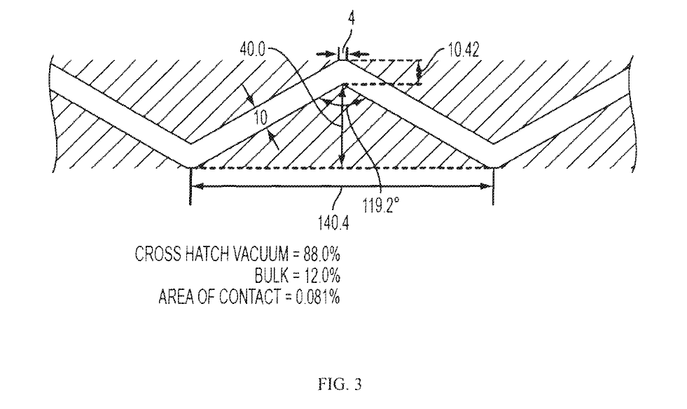

To increase the thermal resistance of the stratum, other intermediate layers may be inserted between or positioned at an angle to the existing layers of a stratum. In some embodiments, the intermediate layer may include a substrate having at least one structure. The intermediate layer material may be any polymer, ceramic or composite material consistent with the end application. In some embodiments, the intermediate layer is of a specific design that minimizes the volume of the intermediate layer material relative to its vacuum volume and minimizes the contact area to the layers above and below it, thereby reducing thermal conduction through the material of these layers. One non-limiting example of an intermediate layer design that simultaneously maximizes vacuum area while providing structural support is a thin accordion-like structure. A cross-sectional view of an accordion shape is illustrated in FIG. 3. The top of the triangular structure of the accordion may be made to a pre-determined width so that the contact area to the surfaces above and below may be controlled. A dual intermediate layer design may be used where the projections are placed orthogonal to each other to maximize thermal resistance and structural strength when a vacuum is drawn.

In some embodiments of the invention, the shape of at least one structure of a second ceramic or polymer layer may be the same as the shape of at least one structure of a first ceramic or polymer layer. The structure of the second ceramic or polymer layer may be rotated and angled differently than the structure of the first ceramic or polymer layer. In other embodiments, the structure of the second ceramic or polymer layer may be different than the shape of the structure of the first ceramic or polymer layer. In particular embodiments of the invention, the second ceramic or polymer layer may be positioned over the first ceramic or polymer layer with the corresponding structures touching. In others, the second ceramic or polymer layer may be positioned over the first ceramic or polymer layer with the corresponding substrates touching.

In further embodiments of the invention, the structure periodicity per layer may differ, so that the layers of the stratum are effectively staggered to minimize the thermally conductive path and maximize the thermal resistance. In certain embodiments, an insulating material device may include at least two stratum where one stratum may have a different set of periodicities than the second stratum. Alternatively, the two strata may have the same set of periodicities, but one stratum may be offset or staggered from the second stratum. In addition, the orthogonal configuration of two layers of insulating material may form a rigid structure, so in certain embodiments, in order to impart flexibility to the insulating material, internal breakpoints of each layer may be aligned to each other.

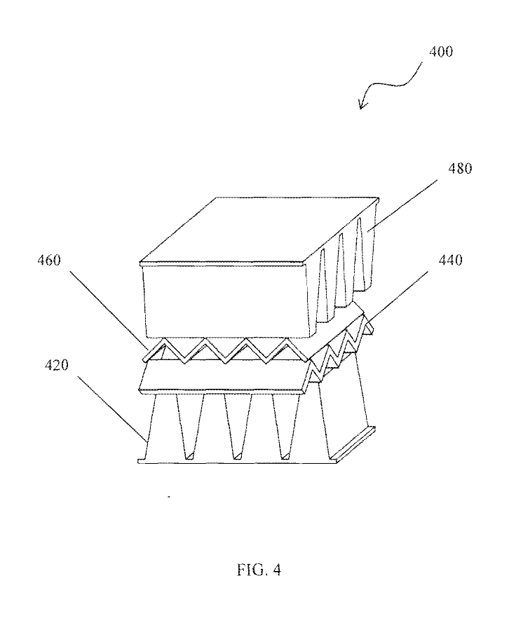

In various embodiments of the invention, as shown in FIG. 4, four layers, two of each type, create a stratum. In particular, FIG. 4 is a cross-sectional view of a stratum 400 having four layers where the first layer 420 has a lenticular projection design and the projection tips face away from the area to be insulated, the second layer 440 is of an accordion-shape structure and is placed orthogonal to the first layer 420, a third layer 460 is also of an accordion-shape structure is placed orthogonal to the second layer 440, and a fourth layer 480 of a lenticular projection design is placed orthogonal to the third layer 460 with the wide end or base portion facing the ambient environment or another stratum. For the case of a single substrate that has projections from both sides (or two layers where the substrates are in contact), the projection tips will face the area to be insulated. In some embodiments, the third layer or second layer in the stratum may be placed offset from the first layer beneath it to increase the thermal resistance. In other embodiments, the fourth layer in the stratum may be placed offset from the second layer beneath it to increase the thermal resistance.

The insulating material devices of the invention may be utilized in concert with each other to further increase the thermal resistance value (R). In some embodiments, the structures of such devices may be positioned the largest distance apart as possible, to increase thermal resistance by reducing the material mass as a ratio to vacuum area. The distance is only limited by its structural strength, and therefore, the inherent capability to not collapse as the pressure is reduced to create the vacuum. In addition, the distance is designed to limit the pull downward of material between structures, thereby thermally “shorting out” the vacuum region by having the base of either of the layers touch the region covered or protected by the thermal resistor or the external thermal reservoir (i.e., the ambient environment). When this occurs, the conduction through each layer is increased and the thermal resistance is thereby decreased.

Between any two layers, or one per stratum, there may be one or more layers of highly reflecting material or surface reflective material where the reflectivity might be specular or diffuse. In other embodiments, the ceramic or polymer layer may include a surface reflective material. As used herein, the term “highly reflective” means in excess of about 80%. The highly reflecting material may include metal foil or metalized film. Non-limiting examples include aluminum foil, gold foil and aluminized or double aluminized MYLAR® film (MYLAR® is a trademark of E.I. Du Pont De Nemours and Company, Delaware, USA). In other embodiments, the highly reflecting material may include a dielectric material, such as, for example, titanium dioxide. In particular embodiments of the invention, the reflective material layer includes a single layer of highly reflective material. In other embodiments, the reflective material layer comprises a multilayer stack of highly reflective material.

In some embodiments, the highly reflecting material layer will have a thickness of about 0.025 μm to about 10 μm. Thickness values of about 0.025 μm to about 1 μm are common for metal foils while values of about 1 μm to about 10 μm are common for metalized films. In preferred embodiments, the highly reflecting material layer will have a thickness of less than or equal to about 1.0 μm. The presence of the highly reflecting material increases thermal resistance by reducing the thickness of the vacuum region so that the mean free path of remaining particles in the vacuum is closer to the vacuum thickness and the reflecting material reflects the infrared. In particular embodiments of the invention, a reflective material coating may be applied to a portion of the structures, such as projections, to prevent or minimize radiation through each layer. In some embodiments, each side or the face of the structures are coated with a reflective metal, meaning that each stratum may contain four metalized surfaces. In some multilayer embodiments of the invention, the surface reflective material of a first ceramic or polymer layer may face the surface reflective material of a second ceramic or polymer layer.

In various embodiments of the invention, the stratum may be contained in a protective polymer coating that enables and protects the vacuum and is with or without a reflective surface. In certain embodiments, the stratum may be contained in a polymer pouch or jacket that can sustain a vacuum panel from about 6 months to about 50 years. In some embodiments, the pouch may include a multilayered structure that includes gas and/or moisture barriers per layer, nano-coating material, as well as heat seal layers.

The gas and/or moisture barrier layers may contain thin (about 30 to 60 nm) layers of vacuum deposited materials, such as, for example, aluminum, which may provide a physical impermeable barrier to gas diffusion as well as act as a reflector to radiation. Additionally, the gas and/or moisture barrier layers may contain organic materials such as, for example, polyvinylidene chloride (PVdC), ethylene vinyl alcohol (EVOH), or polyvinyl alcohol (PVOH) to intensify the gas barrier properties. In yet other embodiments, the temperature may be engineered to fluctuate in a cyclical manner to promote degassing, and a cyclical pulsating movement may be added to encourage molecule movement in layers while multiple stratum are degassed. Other materials, such as, for example, nano-sized aluminum oxide, can be used as a surface coating that acts as a getter.

After the stratum are placed in the pouch or jacket, in some embodiments of the invention, inert gas, such as argon or xenon, may be pumped into the pouch to replace the ambient air before the vacuum is pulled and the pouch is sealed. This improves the thermal resistance of the insulating material device because the thermal conductivity of the argon and xenon is relatively lower than that of air. In another embodiment, the stratum is dried at 50° C. to 90° C. prior to be held under vacuum. The level of vacuum required varies based on a number of factors including, but not limited to, the desired application, structure, design and configuration of layers, number of layers, and the insulating value (R) required. In various embodiments, the near vacuum pressure is about 10⁻⁶ bar or less, and in certain embodiments, the level of vacuum required may range from about 10⁻³ bar to about 10⁻⁶ bar. In certain embodiments of the invention, a double or multiple chamber assembly system is utilized whereby the strata and the protective polymer barrier coating are degassed simultaneously and the pressure is lowered separately. Degassing can occur using baking either prior to or while under vacuum, or possibly both to achieve the best effect.

In certain embodiments, pouch closure may be accomplished via heat sealing using high-density polyethylene (HDPE), oriented polypropylene (OPP), cast polypropylene (CPP), or amorphous polyethylene terephthalate (A-PET).

The insulating material of the invention may be fabricated by any method utilized in the industry as appreciated by one skilled in the art, including, but not limited to, injection molding and/or micro replication techniques. In one embodiment, a master mold may be machined with the desired structures. The master mold may be diamond turned, laser etched or chemically etched, depending on, for example, the size of the features of the structures. The structures may then be formed via embossing (thermal), cast and cure (UV initiated), or other injection molding techniques. A web-based roll process or other roll process may be utilized. In certain embodiments, the roll process operates initially, at lines speeds of about 30 to 50 m min⁻¹. The resulting sheet may be up to two meters wide and may be customized to desired lengths and widths. In some embodiments, the sheets may be manipulated using an automated process and placed into a polymer jacket, with the jacket atmosphere enhanced with a gas such as, for example, argon or xenon before being placed under vacuum.

In some embodiments of the invention, additional hot sealing techniques may be used post vacuum sealing to add a cell-like sealing matrix. This is preferable in applications, such as, for example, where there is a potential for the insulating material device to be punctured, thereby minimizing the insulating effects.

The insulating material in accordance with the invention may be utilized to insulate any object. In some embodiments, the insulating material may be utilized to aid in maintaining the temperature of items at a desired temperature. In other embodiments, the insulating material may prevent heat loss from an item. Examples of applications include, but are not limited to, food packaging, beverage cans, bottles, flexible beverage pouches, insulation of power transmission cables and equipment, transfer and transportation systems for liquid cryogens, heat pipes, heat pumps, space launch vehicle propellant tanks and feed lines, refrigeration units, appliances, medical packaging (e.g., for vaccines), medical transportation boxes, containers of any type, transfer and transportation of carbon dioxide, ammonia, chilled water or brine, oil and steam, and residential applications such as lining of woodboards, plasterboards, roof insulation, vacuum insulated material, and the like.

In particular embodiments of the invention, the insulating material device may be a component of a container such as, for example, a metal container having a double wall. For example, the insulating material may be formed into the shape of a cylinder corresponding to the shape of a double wall metal beverage container and be utilized to insulate the contents of such container. In some embodiments, the insulating material may have a wall thickness of less than about 2 mm and may be placed in between the two walls of the double wall beverage container. The double wall container may then be sealed. As understood by one skilled in the art, the double wall beverage container may be vacuumed sealed or in alternative embodiments may not be vacuum sealed and merely sealed to protect the contents located therein.

Although the foregoing refers to particular preferred embodiments, it will be understood that the present invention is not so limited. It will occur to those of ordinary skill in the art that various modifications may be made to the disclosed embodiments and that such modifications are intended to be within the scope of the present invention, which is defined by the following claims.

What is claimed is:

1. An insulating material, comprising:
an open cell network formed of a ceramic or polymer layer, wherein the ceramic or polymer layer comprises a substrate having at least one structure, and wherein the arrangement of the ceramic or polymer layer allows for the creation of a high-volume cavity near vacuum pressure within each of the layers that may be sealed using vacuum barriers at the perimeter of the ceramic or polymer layer.

2. The insulating material of claim 1, wherein said open cell network is characterized by at least 40% vacuum area relative to material volume.

3. The insulating material of claim 1, wherein said structure provides structural support to the cavity while creating a large volume region enabling the open cell structure.

4. The insulating material of claim 1, wherein said structure is characterized by a base portion that is larger than a tip portion.

5. The insulating material of claim 1, wherein said structure comprises a lenticular projection, accordion-like structure, post and post cross-sections that are t-shaped, u-shaped, square, rectangular, or any irregular or regular polyhedron, post and post cross-sections that are curved, circular, hooked, elliptical, and combinations thereof.

6. The insulating material of claim 1, wherein said structure is a lenticular projection.

7. The insulating material of claim 6, wherein the sides of the lenticular projection are curved, straight or a combination thereof.

8. The insulating material of claim 1, wherein the ceramic or polymer layer comprises multiple structures.

9. The insulating material of claim 8, wherein the structures extend from one side of the substrate.

10. The insulating material of claim 8, wherein the structures extend from both sides of the substrate.

11. The insulating material of claim 1, wherein the ceramic or polymer layer comprises multiple substrates stacked in such a way as to increase the thermal resistance of the insulating material.

12. The insulating material of claim 1, wherein the ceramic or polymer layer comprises a surface reflective material.

13. The insulating material of claim 12, wherein the surface reflective material is comprised of aluminum foil, gold foil, or aluminized or double aluminized MYLAR® film.

14. The insulating material of claim 12, wherein the surface reflective material comprises a highly reflective dielectric material.

15. The insulating material of claim 14, wherein the highly reflective dielectric material is titanium dioxide.

16. The insulating material of claim 12, wherein the thickness of the surface reflective material is less than or equal to about 1.0 μm.

17. The insulating material of claim 12, wherein the surface reflective material is coupled to each face of the at least one structure.

18. The insulating material of claim 1, wherein the near vacuum pressure is a maximum of about 10⁻³ bar.

19. The insulating material of claim 1, wherein the near vacuum pressure is about 10⁻⁶ bar or less.

20. The insulating material of claim 1, wherein the thickness of the insulating structural material is from about 0.01 mm to about 1 mm.

21. The insulating material of claim 1, further comprising a second ceramic or polymer layer, wherein the second ceramic or polymer layer comprises a substrate having at least one structure to form a stratum.

22. The insulating material of claim 21, wherein the ceramic or polymer layer comprises multiple structures.

23. The insulating material of claim 22, wherein the structures extend from one side of the substrate.

24. The insulating material of claim 22, wherein the structures extend from both sides of the substrate.

25. The insulating material of claim 21, wherein the structure is integral to the substrate.

26. The insulating material of claim 21, wherein the shape of the at least one structure of the second ceramic or polymer layer is the same as the shape of the at least one structure of the first ceramic or polymer layer.

27. The insulating material of claim 22, wherein the at least one structure of the second ceramic or polymer layer is rotated and angled differently than the at least one structure of the first ceramic or polymer layer.

28. The insulating material of claim 21, wherein the shape of the at least one structure of the second ceramic or polymer layer is different than the shape of the at least one structure of the first ceramic or polymer layer.

29. The insulating material of claim 21, wherein the periodicity of the at least one structure of the second ceramic or polymer layer is the same as the periodicity of the at least one structure of the first ceramic or polymer layer.

30. The insulating material of claim 21, wherein the periodicity of the at least one structure of the second ceramic or polymer layer is different than the periodicity of the at least one structure of the first ceramic or polymer layer.

31. The insulating material of claim 21, wherein the second ceramic or polymer layer is positioned over the first ceramic or polymer layer with the corresponding structures touching.

32. The insulating material of claim 21, wherein the second ceramic or polymer layer is positioned over the first ceramic or polymer layer with the corresponding substrates touching.

33. The insulating material of claim 21, wherein the at least one structure of the second ceramic or polymer layer is positioned parallel to the at least one structure of the first ceramic or polymer layer.

34. The insulating material of claim 33, wherein the thermal resistance of the insulating material is approximated by a cylindrical thermal conductor.

35. The insulating material of claim 21, wherein the at least one structure of the second ceramic or polymer layer is positioned orthogonal to the at least one structure of the first ceramic or polymer layer.

36. The insulating material of claim 35, wherein the thermal resistance of the insulating material is approximated by a spherical thermal conductor.

37. The insulating material of claim 21, wherein the second ceramic or polymer layer comprises a surface reflective material.

38. The insulating material of claim 37, wherein the surface reflective material of the second ceramic or polymer layer is comprised of aluminum foil, gold foil or aluminized or double aluminized MYLAR® film.

39. The insulating material of claim 37, wherein the surface reflective material of the second ceramic or polymer layer comprises a highly reflective dielectric material.

40. The insulating material of claim 39, wherein the highly reflective dielectric material is titanium dioxide.

41. The insulating material of claim 37, wherein the thickness of the surface reflective material of the second ceramic or polymer layer is less than or equal to about 1.0 μm.

42. The insulating material of claim 37, wherein the surface reflective material of the second ceramic or polymer layer is coupled to each face of the at least one structure.

43. The insulating material of claim 37, wherein the surface reflective material of the second ceramic or polymer layer faces the surface reflective material of the first ceramic or polymer layer.

44. The insulating material of claim 21, further comprising an intermediate layer, wherein said intermediate layer comprises a substrate having at least one structure.

45. The insulating material of claim 44, wherein the intermediate layer is located between the first ceramic or polymer layer and the second ceramic or polymer layer to form a stratum.

46. The insulating material of claim 44, wherein the intermediate layer comprises multiple structures.

47. The insulating material of claim 44, wherein the intermediate layer is positioned at an angle to the first ceramic or polymer layer.

48. The insulating material of claim 44, wherein the intermediate layer is positioned at an angle to the second ceramic or polymer layer.

49. The insulating material of claim 48, wherein the structures of the intermediate layer extend from one side of the substrate.

50. The insulating material of claim 48, wherein the structures of the intermediate layer extend from both sides of the substrate.

51. The insulating material of claim 44, wherein the structure is integral to the substrate.

52. The insulating material of claim 44, wherein the shape of the at least one structure of the intermediate layer is the same as the shape of the at least one structure of the second ceramic or polymer layer and the shape of the at least one structure of the first ceramic or polymer layer.

53. The insulating material of claim 44, wherein the shape of the at least one structure of the intermediate layer is different than the shape of the at least one structure of the second ceramic or polymer layer and the shape of the at least one structure of the first ceramic or polymer layer.

54. The insulating material of claim 44, wherein the at least one structure of the intermediate layer is an accordion-like structure.

55. The insulating material of claim 54, wherein the top of the triangular portion of the accordion-like structure is of a predetermined width so that the contact area to the surfaces above and below the accordion-like structure is controlled.

56. The insulating material as in any of claims 1-55, wherein the insulating material is vacuum sealed in a protective polymer coating that enables and protects the vacuum and is with or without a reflective surface.

57. The insulating material as in any of claims 1-55 that is a flexible panel.

58. The insulating material as in any of claims 1-55 that is a micro replicated structure manufactured by cast and cure or embossing methods.

59. An article of manufacture comprising the insulating material of claim 1, selected from the group consisting of: food packaging; beverage cans; bottles; flexible beverage pouches; insulation for power transmission cables and equipment; transfer and transportation systems for liquid cryogens; heat pipes, heat pumps, vehicle propellant tanks; feed lines; refrigeration units; appliances; medical packaging; medical transportation boxes; containers; transfer and transportation systems for carbon dioxide, ammonia, chilled water or brine, oil and steam; woodboards; plasterboards; roof insulation; and vacuum insulated materials.

60. An insulating material device, comprising:
a four-layer stratum comprising an open cell network formed of a first ceramic or polymer layer, wherein the first ceramic or polymer layer comprises a first structure; a second ceramic or polymer layer, wherein the second ceramic or polymer layer comprises a second structure; a first intermediate layer, wherein the first intermediate layer comprises a third structure; a second intermediate layer, wherein the second intermediate layer comprises a fourth structure and a reflective material layer, wherein the arrangement of the first and second ceramic or polymer layers, the first and second intermediate layers, and the reflective material layer allows for the creation of a vacuum within each of said layers that may be sealed; and
a protective polymer coating, wherein about 1% or less of the total surface area of the first, second, third and fourth structures are in contact with each other.

61. The insulating material device of claim 60, further comprising a surface reflective material.

62. The insulating material device of claim 60, wherein said open cell network is characterized by at least 40% vacuum area relative to material volume.

63. The insulating material device of claim 60, wherein the first and second intermediate layers are ceramic or polymer layers.

64. The insulating material device of claim 60, wherein any of the first, second, third and fourth structures are characterized by a base portion that is larger than a tip portion.

65. The insulating material device of claim 64, wherein the base portion is attached to a base substrate.

66. The insulating material device of claim 60, wherein any of the first, second, third and fourth structures are lenticular projections.

67. The insulating material device of claim 60, wherein any of the first, second, third and fourth structures are accordion-like structures.

68. The insulating material device of claim 60, wherein the reflective material layer is comprised of aluminum foil, gold foil, or aluminized or double aluminized MYLAR® film.

69. The insulating material device of claim 60, wherein the reflective material layer comprises a highly reflective dielectric material.

70. The insulating material device of claim 69, wherein the highly reflective dielectric material is titanium dioxide.

71. The insulating material device of claim 60, wherein the thickness of the reflective material layer is less than or equal to about 1.0 μm.

72. The insulating material device of claim 60, wherein the reflective material layer is coupled to at a least a portion of at least one of the first, second, third and fourth structures.

73. The insulating material device of claim 60, wherein the reflective material layer is a multilayer stack.

74. The insulating material device of claim 60, further comprising a cell-like sealing matrix layer.

75. The insulating material device of claim 60, wherein said insulating material device can sustain a vacuum from about 6 months to about 50 years.

76. The insulating material device of claim 60, further comprising a gas barrier per layer.

77. The insulating material device of claim 60, further comprising a moisture barrier per layer.

78. The insulating material device of claim 60, further comprising a nano-coating material, wherein the nano-coating material acts as a getter.

79. The insulating material device of claim 60, further comprising multiple internal perimeter vacuum sealed layers.

80. The insulating material device of claim 60, further comprising a layer of vacuum deposited metals.

81. The insulating material device of claim 60, wherein said insulating material device is formed to a predetermined portion of the surface of a container.

82. The insulating material device of claim 60, further comprising at least a second stratum of four layers, wherein said second stratum comprises an open cell network formed of a first ceramic or polymer layer, wherein the first ceramic or polymer layer comprises a first structure; a second ceramic or polymer layer, wherein the second ceramic or polymer layer comprises a second structure; a first intermediate layer, wherein the first intermediate layer comprises a third structure; a second intermediate layer, wherein the second intermediate layer comprises a fourth structure and a reflective material layer, wherein the arrangement of the first and second ceramic or polymer layers, the first and second intermediate layers, and the reflective material layer allows for the creation of a vacuum within each of said layers that may be sealed.

83. The insulating material device of claim 82, wherein the shapes of the first, second, third and fourth structures of the first stratum are the same as the corresponding shapes of the first, second, third and fourth structures of the second stratum.

84. The insulating material device of claim 82, wherein the shapes of the first, second, third and fourth structures of the first stratum are different than at least one of the corresponding shapes of the first, second, third and fourth structures of the second stratum.

85. The insulating material device of claim 82, wherein the first stratum and the second stratum have the same periodicity layer by corresponding layer.

86. The insulating material device of claim 82, wherein the first stratum and the second stratum have different periodicities in at least one corresponding layer.

87. The insulating material device of claim 82, wherein at least one layer in the first stratum is offset from the corresponding layer of the second stratum.

88. The insulating material device of claim 82, wherein each of the first and second strata have an internal breakpoint and wherein said internal breakpoints of the first stratum and the second stratum are aligned to impart a level of flexibility to the insulating material device.

89. The insulating material device of claim 82, formed in the shape of a cylinder or substantially cylindrically shaped and sealed at a near vacuum pressure to create an insulating interior or exterior layer for a beverage or other container.

90. The insulating material device of claim 82, wherein at least one of the first, second, third and fourth structures of the first stratum is positioned at an angle to at least one of the first, second, third and fourth structures of the second stratum.

91. The insulating material device of claim 82, wherein at least one of the first, second, third and fourth structures of the first stratum is positioned orthogonal to at least one of the first, second, third and fourth structures of the second stratum.

92. The insulating material device of claim 82, wherein at least one of the first, second, third and fourth structures of the first stratum is positioned parallel to at least one of the first, second, third and fourth structures of the second stratum.

93. The insulating material device of claim 82, wherein said insulating material device is dried.

94. The insulating material device of claim 82, wherein said insulating material device is vacuum sealed to maintain a near vacuum between the layers.

95. The insulating material device of claim 82, wherein said insulating material device is heat sealed under vacuum at the perimeter of the device.

96. The insulating material device of claim 82, wherein said insulating material device is vacuumed heat sealed at the perimeter of the device simultaneously with a gas and moisture barrier material that extends to the perimeter of said device.
